(19) United States
(12) Patent Application Publication
(10) Pub. No.: US 2008/0086553 A1
(43) Pub. Date: Apr. 10, 2008

(54) Device, Particularly a Plug-In Card, for a Data Processing Device

(75) Inventor: Holger Theobald, Hohen Neuendorf (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: NETCHILLI GMBH, BERLIN (DE)

(21) Appl. No.: 11/659,575

(22) PCT Filed: Aug. 1, 2005
(86) PCT No.: PCT/EP05/08301

§ 371 Date: Feb. 7, 2007

(30) Foreign Application Priority Data
Aug. 11, 2004 (DE) 10 2004 039 809.7

(51) Int. Cl. G06F 15/16

(52) U.S. Cl. 709/223

(57) ABSTRACT

The invention relates to a device (1), particularly a plug-in card, for a data processing device (2), e.g. for a computer, a printer or the like, the data processing device (2) being networked with at least one other data processing device (4, 6). The data processing device (2) comprises a main board (22) with interfaces (26, 28, 30, 32, 34, 36, 40, 42) for other components of the data processing device (2) and/or for the interaction of the data processing device (2) with a user including an interface (42a, 42b) to an electrical switching element (44, 46), via whose actuation the data processing device (2) can be switched on, switched off or reset. The device (1) is connected to a controller (14) via a network (16). The invention is characterized in that the device (1) has a power supply over the network (16), said power supply being independent from the data processing device (2), and that the device (1) is connected to at least a portion of the interfaces (26, 28, 30, 32, 34, 36, 40, 42) of the main board (22) of the data processing device (2) including the interface (42a, 42b) to the electrical switching element (44, 46) via whose actuation the data processing device (2) can be switched on, switched off or reset.

The invention relates to a device for a data processing device, particularly a plug-in card, for controlling a data processing device via a network.

It is conventional for data processing devices, such as for example personal computers, to be networked to one another over a data network by data systems engineering. Data are exchanged according to a standardized protocol, for example according to the Ethernet protocol, over a data network. In many applications data networks are hierarchically structured, with one or more network nodes to which so-called client computers are connected which can customarily be workstation computers, or so-called server computers, which generally have higher performance than client computers.

In many applications the client computers are located spatially apart from one another, for example in different rooms of a building, in different buildings at one location, and/or at different locations. In particular, in a business environment data processing devices are potentially located several hundred or even several thousand kilometers apart.

In the context of maintenance and system upkeep it may be necessary for one, several or all data processing devices which are networked to one another by data systems engineering to be accessed. Generally this takes place by a so-called system administrator which is authorized to access the data processing device via the data network from the server computer or one of the client computers and to carry out the required measures. This can be for example an update of the software installed on the server computer or client computers, matching of the database on the server computer or individual client computers or the like. For this purpose it is necessary for the data processing device to be addressed to be in operation. If necessary an individual must be detailed to put the data processing device to be addressed in the required operating state. This is associated with considerable time consumption and cost.

US 2003/0135654 A1 shows a control device which can be operated over a wide area network (WAN) from a remote monitor and which in addition to the WAN interface also has a LAN interface to a local area network (LAN). Over the LAN several computers which can be started from an offline state by means of so-called wake-on-LAN technology can be locally connected to one another.

U.S. Pat. No. 6,047,378 shows the structure of a data transmission block which is used on a LAN for transmission of a wake signal to several computers.

Therefore the object of the invention is to make available a device which overcomes the disadvantages of the prior art.

This object is achieved by the device specified in claim 1. Special embodiments of the invention are defined in the dependent claims.

In a device, especially a plug-in card, for a data processing device, for example for a computer, a printer or the like, the data processing device being networked by data systems engineering to at least one other data processing device, and the data processing device having a main board with interfaces for other components of the data processing device and/or for interaction of the data processing device with a user, including an interface to an electrical switching element, by actuation of which the data processing device can be turned on, off, or reset, and the device being connected via a network to a controller, the object is achieved in that the device has a power supply which is independent of the data processing device via the network, and that the device is connected to at least one part of the interfaces of the main board of the data processing device including the interface to the electrical switching element, by actuation of which the data processing device can be turned on, off, or reset.

The data network via which the data processing devices are networked to one another by data systems engineering can be made DC-decoupled relative to the network to which the device as claimed in the invention with the controller is connected. An embodiment of the device such as this has the advantage that the data transmission speed for data traffic on the data network is not reduced by the data traffic between the device and the controller. Moreover, in this way power supply of the device as claimed in the invention can be made available with simple means.

In one alternative embodiment of the invention the data network and network for connection between the device as claimed in the invention and the controller are integrated in a common network. This common network can be built for example on an already standardized network protocol and can be expanded only by the functionalities of the device as claimed in the invention. In this case power supply of the device as claimed in the invention also takes place independently of the power supply of the data processing device.

Main board interfaces are defined not only as the known standardized interfaces for data transmission or triggering of other components of the data processing device, such as for example the so-called IDE interface for connection of hard disks, the so-called PCI interface for connection of plug-in cards, the parallel or serial interface and/or universal serial interface USB, but basically as all interfaces of the main board with connectable components, for example with actuating switches, input devices such as keyboard or mouse, or output devices such as display lamps, speakers or screens. Thus for example the currently conventional personal computer on its main board has interfaces for light emitting diodes for indication of the on state and the activity of disk storage, as well as a button or switch for turning on and off and a button for resetting (RESET) of the data processing device.

The main board is generally a comparatively large circuit board on which the essential components of a computer system are located, especially the processor, which is also called a central processing unit (CPU). Other components such as the memory modules, plug-in cards for sound, graphics, video, networks, or modem can generally be detachably fixed on the main board via the corresponding plug connection means.

The device as claimed in the invention makes it possible to turn on, turn off or reset the data processing device controlled by a controller. In this way, for example for loading updated software onto the data processing device, a data processing device which has been turned off can first be turned on from a remote active administrator, then the software updated, and finally the data processing device can be turned off again. In addition, the data processing device, if necessary, can be reset via the device into the base state, for example restarted, in the event that the data processing device cannot be operated in the regular manner via networking by data systems engineering. All this can take place without an operator working on site on the data processing device.

In this connection it is especially advantageous that the power supply of the device is independent of the power supply of the data processing device. Modern data processing devices are also in the off state in the so-called stand-by mode from which they can be easily started up with the device as claimed in the invention. This applies both to a first possible stand-by mode in which the data processing device is off, but the power pack of the main board is supplied with power, and also in a second possible stand-by mode in which the main board supports the corresponding power saving modes, such as for example APM (Advanced Power Management) or ACPI (Advanced Configuration Power Interface) in which parts of the data processing device are tuned off and can be re-activated by actuating a key.

The connection of the device to the interfaces of the main board of the data processing device takes place preferably by metallic connections, for example by looping connecting lines through between the main board and other components of the data processing device via the board of the device as claimed in the invention. In the device, DC-decoupling between the control and looped connecting lines can take place, for example by an optical coupler located on the board of the device or by electromechanically actuated switches such as a relay or reed relay. The device as claimed in the invention can have detachable connecting elements, especially plug or screw connecting elements which are compatible with the corresponding connecting elements of the data processing device, so that the device can be installed by simply changing over the existing connecting lines of the data processing device.

Both the data network and also the network between the device and the controller can be implemented in pure form or mixed form of different network types. Basically peer-to-peer networks and client-server networks are distinguished. Peer-to-peer networks are a simple possibility for interconnecting several computers, generally the individual data processing devices having equal access in a peer-to-peer network. The user of the data processing device himself determines which data and devices he releases to others for access. Here it also applies that the resources of a data processing device can only be used when it is in the on state.

Within the scope of this invention, the networks will preferably be made as a client-server network which is hierarchically structured, in contrast to the peer-to-peer network. In a client-server network a so-called server-computer assumes central tasks, for example administration of network resources such as hard disks, printer, modem, scanner and the like and making available services such as for example computing capacity. Generally a server-computer operates several client computers at the same time.

Networks can be configured in various topologies, for example star, ring, tree, and mesh topology, mixed forms also being possible.

In one special embodiment of the invention the device is connected to the power pack of a data processing device, especially to the power supply line of the power pack for another component of the data processing device. In this way it can be easily determined for the device whether the data processing device is on or off. Preferably one of the numerous power supply lines of the power pack which are not required for the data processing device is connected to a board of the device for this purpose. The operating state of the data processing device determined in this way can be transmitted from the device to the controller so that for example an administrator can decide whether certain measures, for example transfer of updated software, is possible in the respective operating state of the data processing device.

In one special embodiment of the invention the device with an interface is connected to a display element or sensor element present in the data processing device. For example the operating state of one or more of the light emitting diodes which are located on the housing of the data processing device and which display the operating state or access of a data storage can be determined and can be transmitted via the network to the controller. Furthermore, many data processing devices have sensor elements for the temperature of the processor or the main board, or for the rotational speed of a fan; this information can also be transmitted via the device and the network to the controller and for example to an administrator.

In one special embodiment the device is connected to the so-called system management interrupt (SMI) interface of the main board. This for example two-pole interface makes it possible to shift the data processing device into a power saving mode, for example by storing the current contents of the main memory on a preestablished partition of the hard disk from which the contents are reloaded into the main memory when the data processing device is restarted.

In one special embodiment of the invention the device is connected to standardized interfaces of the main board, for example for data transmission to or from peripherals of the data processing device. Examples of these standardized and currently conventional interfaces or data bus protocols are for example serial and parallel interfaces, USB (universal serial bus) interfaces, accelerated graphics port (AGP) interfaces, firewall interfaces according to standard IEEE 1384, interfaces for wireless transmission by optical waves or radio waves such as Bluetooth or infrared and the like; this list is not conclusive and future interfaces and standards can also be controlled as claimed in the invention. These interfaces can be temporarily or permanently deactivated or activated by the device as claimed in the invention from a remotely located administrator without access locally on the data processing device being necessary for this purpose.

The device can also control some or all of the functions which can be set with a so-called jumper on the main board, instead of simple wire bridges, board switches often being used. Thus it is not necessary to open the housing of the data processing device in order to undertake settings on the clock frequency or in order to write a read-only memory, for example to flash the BIOS (Basic Input Output System) of the data processing device. Preferably the pertinent connections are routed from the main board to the device similarly to the interfaces to be controlled.

In one special embodiment of the invention the device has at least one sensor element for detecting the status of the data processing device or of ambient conditions of the data processing device, and this status information can be transmitted via the network to the controller. With sensors for temperature, humidity and/or air pressure for example ambient atmospheric conditions can be detected and transmitted to the controller. Alternatively or in addition there can be photosensors, for example simple photodiodes, as well as static picture and motion picture cameras, by means of which optical inspection of the data processing device is also possible from a remote location even if the data processing device has been turned off by the user; if necessary an illuminant for lighting the data processing device can also be integrated into the device.

Another possibility can be a housing switch by means of which opening of the housing of the data processing device can be detected. Alternatively or in addition opening or closing of the housing can also be detected by an air pressure sensor. With a sensor for air circulation for example alone or in combination with a temperature sensor it can be detected whether sufficient cooling of the data processing device is ensured. With a microphone or vibration sensor, vibrations which are for example unallowable especially in the operating state can be detected and signaled. Accordingly the display elements present already in the data processing device can be used for signaling certain, for example critical operating states, for example a so-called system warning speaker or display light emitting diodes which can be controlled from the controller via the network and the device as claimed in the invention.

In one special embodiment of the invention the data processing device can be shifted into an operating state in which interaction is possible only via the device, the network and the controller. In particular, an interaction, for example turning on or turning off or data input via a keyboard or mouse, can be prevented by a user locally at the site of the data processing device. In this way for example when software is being currently updated, the data processing device can be prevented from being turned off or from being transferred into an operating state which is unallowable for updating of software by a user locally on site. In this connection, as claimed in the invention only certain local interactions can be prevented; for example data inputs via the keyboard or mouse can still be allowed, but the data processing device can be prevented from being turned off.

Likewise, certain accesses to interfaces, for example the parallel, serial or USB interface can also be temporarily or permanently prevented and the data processing device in this respect can be locked in terms of data systems engineering. In this way abuse of data can be reliably prevented, for example when especially security-relevant data are filed temporarily on the data processing device, for example during a download process or updating of the software.

In one special embodiment of the invention the device is made as a plug-in card, the plug-in card itself or an adapter fixed on it being made such that it can be installed in a rack of the data processing device which is standardized with respect to the geometrical dimensions of its mounting opening. Instead of a plug-in card the device can also be dynamically connected in some other way to the data processing device, for example the device can also be located on the main board or can be integrally formed by the main board.

Other advantages, features and details of the invention will become apparent from the dependent claims and the following description in which several embodiments are described in detail with reference to the drawings. Each of the features in the claims and in the specification may be essential for the invention singly or in any combination with one another.

FIG. 1 shows a configuration of a device as claimed in the invention,

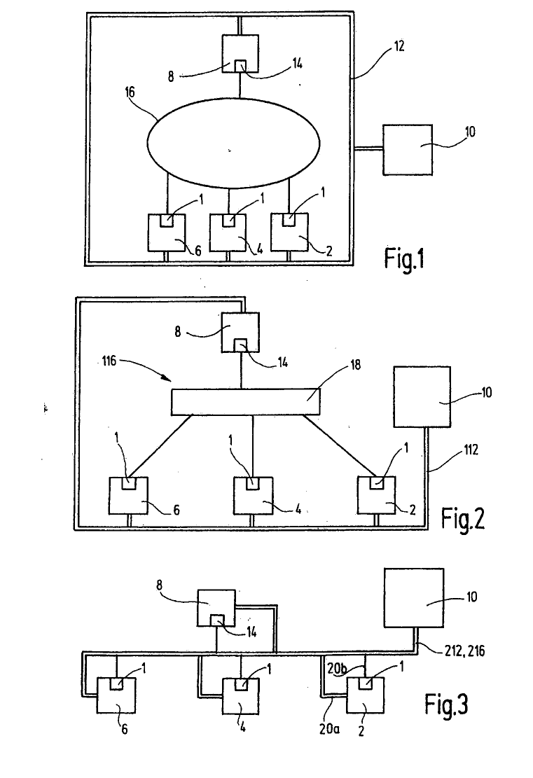

FIG. 2 shows an alternative configuration,

FIG. 3 shows another possible configuration of the data processing device equipped as claimed in the invention, and

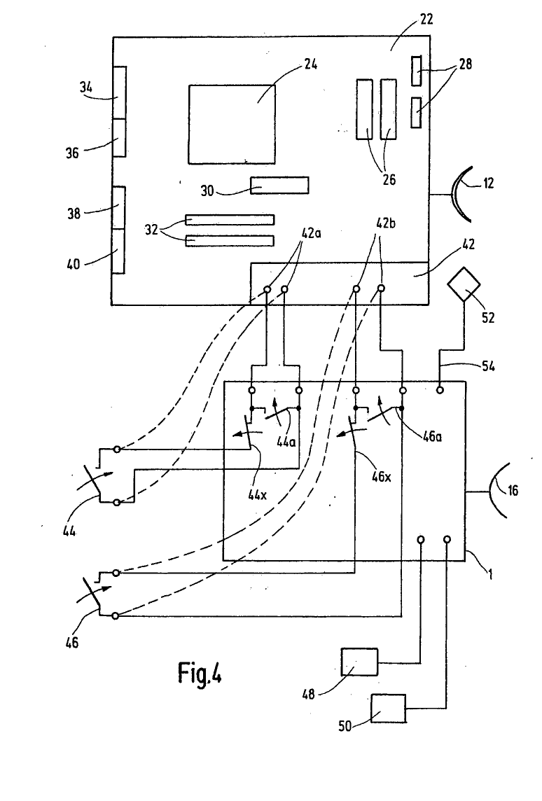

FIG. 4 shows the wiring of a device as claimed in the invention with the main board of the pertinent data processing device.

FIG. 1 shows a configuration as claimed in the invention of a device 1 which is installed as a plug-in card into a first data processing device 2, which is a personal computer. The device 1 can be installed for example on the back of the housing of the first data processing device 2, in a standard rack such that the electrical and/or optical connection means leading to the outside are accessible from outside the housing.

The first data processing device 2 is networked by data systems engineering to other data processing devices 4, 6, 8, 10, in the embodiment via a data network 12 with ring network topology. Two of the other data processing devices 4, 6 are made essentially identical to the first data processing device 2, especially also the two other data processing devices 4, 6 have a device 1 as claimed in the invention. These three data processing devices 2, 4, 6 can be for example conventional workstation computers, workstations or personal computers.

Conversely the other data processing device 10 assumes a server function in the data network 12, i.e., it is a high-performance computer on which for example a standard data base is kept, including application programs, which the other data processing devices 2, 4, 6 access. The data network 12 can be operated for example according to the TCP/IP protocol or according to the Ethernet standard.

In addition to the data network 12, the configuration of FIG. 1 has a network 16 which can be regarded as the control network and to which both the devices 1 of the first data processing device 2 and of the other data processing devices 4, 6 are connected, and also a controller 14 located in a second data processing device 8. The second data processing device 8 can also be made as a workstation computer; alternatively there can also be a means which can be operated simply via one of the data processing devices 2, 4, 6 or especially by the server 10. In a modification of the representation from FIG. 1 the server 10 can also be connected to the network 16 via a device 1. The network 16 also has a ring topology. The devices 1 in the data processing devices 2, 4, 6 are supplied with power via the network 16. This power preferably originates from the controller 14 of the second data processing device 8 or from a hub or switch connected to the network 16.

FIG. 2 shows an alternative configuration in which the data processing devices 2, 4, 6 which are made essentially identically each have the device 1 as claimed in the invention, and are connected via a data network 112 with bus topology to one another and to the server 10 and the data processing device 8 which has the controller 14. The topology with which the controller 14 is connected to the devices 1 is star-shaped in this embodiment, an active distributor 18, for example a so-called hub or switch, being connected between the controller 14 and the devices 1.

FIG. 3 shows another possible configuration of the data processing devices 2, 4, 6 equipped as claimed in the invention, in this embodiment the data network 212 and the network 216 being integrated in a common network, so that separate wiring for the network 216 is not necessary. The common network 212, 216 is implemented with a bus topology in which the computers are linearly connected via a common cable which forms the bus. The cable can be divided for this purpose at a location assigned to the respective data processing devices 2, 4, 6, 8, 10 and a first connecting line 20a can be supplied to the existing network card of the data processing device 2, while a second connecting line 20b is supplied to the device 1 as claimed in the invention, for both connecting lines 20a, 20b, there being their own connecting elements, for example receptacles, on the data processing device 2. In another configuration level in which the protocol of the data networks 212 is integrated into the functionality of the network 216, a single connecting line with a single connecting element can also be used.

In all three embodiments as shown in FIGS. 1 to 3, the data processing devices 2, 4, 6, can be turned on, off or reset by the data processing device 8 in which the controller 14 is installed, via the network 16, 116, 216. For this purpose the devices 1 are connected to the electrical switching element of the data processing devices 2, 4, 6 which causes turning on, turning off or resetting, and connection can take place electrically or without contact, for example via an optical coupler or a relay, especially a reed relay. Here either individual or several of the data processing devices 2, 4, 6 can be individually triggered via the network 16, 116, 216, or all data processing devices 2, 4, 6 which are connected to the network 16, 116, 216 can be controlled jointly.

The second data processing device 8 and especially the controller 14 installed there can be controlled by a system administrator which can be located at any network node. In particular it can be located both on the server 10 and also on one of the other data processing devices 2, 4, 6, 8.

FIG. 4 shows the wiring of a device 1 as claimed in the invention with a main board 22 of the pertinent data processing device 2. The main board 22 in addition to a processor 24 has numerous interfaces for other components of the data processing device 2, including interfaces 26 for memory modules, interfaces 28 for disk drives, an interface 30 for a graphics card, several interfaces 32 for plug-in cards, for example with a PCI bus, and at least one parallel interface 34, a serial interface 36, a USB interface 38 and an audio interface 40. The other components of the data processing device 2 can be connected to the main board 22 by plugging into the main board 22 or by connecting lines. The main board 22 can be connected to the data network 12 via a network card made as a plug-in card.

Moreover the data processing device 2 has a panel 42 either directly on the main board 22 or connected to it via a connecting line; the panel forms one or more interfaces to other components of the data processing device 2. Thus the panel 42 can have for example connecting lines for light emitting diodes with which the presence of the operating position and/or disk access of a disk memory can be indicated. Moreover a speaker can be connected to the panel 42. In addition, on the panel 42 there are also connections of a system management interrupt (SMI) lead by means of which the data processing device 2 can be shifted into the energy saving mode.

FIG. 4 shows simply for reasons of clarity of all these connection possibilities of the panel 42 only the connections for the so-called reset switch or button 44 which is ordinarily located on the housing of the data processing device 2 and the connections for the on/off switch or button 46. In many modem data processing device 2 a so-called ATX current switch or current button is used by which the data processing device 2 can be transferred out of the energy saving mode by a key signal into the operating state and depending on the operating system the data processing device 2 can also be shut down and turned off by pushing a button.

In a known data processing device 2 the connecting lines are routed between the panel 42 and the switching elements 44, 46 as is indicated in FIG. 4 by the broken lines. According to this invention the connecting lines are routed via switching elements which are located on a board of the device 1. In this connection a first additional switching element 44a assumes the function of the reset button 44, in this embodiment simultaneous activation of the switching element 44 located on the housing of the data processing device 2 and of the first additional switching element 44a by the device 1 being possible and also active. But this can be prevented by opening of the second additional switching element 44x controlled by the controller so that only actuation of the reset button 44 by the device 1 is possible. The device 1 is connected via the network 16 to the controller 14, the control of the device 1 for actuating the other switching elements 44a, 44x being DC-decoupled from the looped-through connecting lines.

The corresponding applies to the on/off button 46, with a connecting line likewise looped via the device 1, the first additional switching element 46a being located parallel to the on/off button 46 which is located on the housing of the data processing device 2, and a second switching element 46x being connected in series to the housing switching element 46.

Other interfaces of the main board 22 can likewise also be looped via the device 1 and accordingly the data processing device 2 can be partially or completely controlled by the device 1 and consequently by the controller 14.

For example, by way of the network 16 the device 1 can provide for certain interfaces to be deactivated temporarily or permanently, for example no audio signal to be output, no video signal to be output, or no data transfer over the parallel, serial and/or USB interface 34, 36, 38 to be possible. In particular, several or all interfaces of the panel 42 can be looped through via the device 1 so that triggering of the light emitting diodes or of the system speaker of the data processing device 2 by the device 1 is possible.

Alternatively or in addition, a first sensor 48 is also connected to the device 1 and for example detects whether the housing of the data processing device 2 is closed or opened. Furthermore a second sensor 50 is connected to the device 1, with which acoustic and/or optical ambient signals are received, for example the state of certain components of the data processing device 2 is monitored. A power supply line 54 connects the power pack 52 of the data processing device 2 to the device 1 so that it can be easily detected whether the data processing device 2 is being turned on or off by the user.

1. Device (1), particularly a plug-in card, for a data processing device (2), for example for a computer, a printer or the like, the data processing device (2) being networked by data systems engineering to at least one other data processing devices (4, 6), and the data processing device (2) having a main board (22) with interfaces (26, 28, 30, 32, 34, 36, 40, 42) for other components of the data processing device (2) and/or for interaction of the data processing device (2) with a user, including an interface (42a, 42b) to an electrical switching element (44, 46), by actuation of which the data processing device (2) can be turned on, off or reset, and the device (1) being connected via a network (16) to a controller (14), characterized in that the device (1) has a power supply which is independent of the data processing device (2) via the network (16), and that the device (1) is connected to at least one part of the interfaces (26, 28, 30, 32, 34, 36, 40, 42) of the main board (22) of the data processing device (2) including the interface (42a, 42b) to the electrical switching element (44, 46), by actuation of which the data processing device (2) can be turned on, off or reset.

2. The device (1) as claimed in claim 1, wherein the device (1) is connected to the power pack (52) of a data processing device (2), especially to the power supply line (54) of the power pack (52) for another component of the data processing device (2).

3. The device (1) as claimed in claim 1, wherein the device (1) with an interface is connected to the display element or sensor element present in the data processing device (2).

4. The device (1) as claimed in claim 1, wherein the device (1) is connected to the system management interrupt interface of the main board (22).

5. The device (1) as claimed in claim 1, wherein the device (1) is connected to standardized interfaces (26, 28, 30, 32, 34, 36, 40) of the main board (22) for data transmission to or from peripherals of the data processing device (2).

6. The device (1) as claimed in claim 1, wherein the device (1) has at least one sensor element (48, 50) for detecting the status of the data processing device (2) or of ambient conditions and for transmitting the status information via the network (16) to the controller (14).

7. The device (1) as claimed in claim 1, wherein the data processing device (2) can be shifted by the device (1) into an operating state in which interaction with the data processing device (2) is possible only via the device (1), the network (16), and the controller (14).

8. The device (1) as claimed in claim 1, wherein the network (16) for connection between the device (1) and the controller (14) is DC-decoupled from data systems engineering networking of the data processing device (2) with at least one another data processing device (4, 6).

9. The device (1) as claimed in claim 1, wherein the connection between the device (1) and the controller (14) and the data systems engineering networking of the data processing device (2) with at least one other data processing device (4, 6) are integrated in a common network (212, 216), especially wherein the connection between the device (1) and the controller (14) as well as the data systems engineering networking of the data processing device (2) with at least one other data processing device (2) takes place via a standardized network protocol and a common network.

10. The device (1) as claimed in claim 1, wherein the device (1) is made as a plug-in card which can be installed in a rack of the data processing device (2) which is standardized with respect to the geometrical dimensions of its mounting opening.
